(19) United States
(12) Patent Application Publication
(10) Pub. No.: US 2020/0180577 A1
(43) Pub. Date: Jun. 11, 2020

(54) Brake System for Saddle-Type Vehicle

(71) Applicant: FUELL Inc., New York, NY (US)

(72) Inventors: Erik Buell, Mukwonago, WI (US); Daniel David Hurda, Mequon, WI (US); Edward Matthew Laben, Mukwonago, WI (US)

(21) Appl. No.: 16/706,222

(22) Filed: Dec. 6, 2019

Related U.S. Application Data
(60) Provisional application No. 62/776,036, filed on Dec. 6, 2018.

(51) Int. Cl. B60T 8/17; B60K 7/00; B60L 7/18; B60T 7/08; B60T 8/172; B60T 8/171; B60T 8/1763; B60T 7/04

(52) U.S. Cl. CPC B60T 8/1706; B60K 7/0007; B60L 7/18; B60T 7/042; B60T 8/172; B60T 8/171; B60T 8/1763; B60T 7/085

(57) ABSTRACT

A saddle-type vehicle having at least one seat and at least two wheels, at least one electric motor, a motor controller, a rechargeable energy storage system (RESS) such as a battery and battery management system, at least one friction foundation or ABS braking system as a first braking system and at least one electric regenerative braking system as a second system where the two braking systems are linked to allow for simultaneously providing conventional and regenerative braking independently to the front and rear wheels of the vehicle.

### CROSS-REFERENCE TO RELATED APPLICATION

This application claims priority to U.S. Provisional Application No. 62/776,036 filed on Dec. 6, 2018. The above referenced application is incorporated by reference in its entirety.

### FIELD OF INVENTION

This disclosure relates to braking systems for saddle-type vehicles.

### BACKGROUND OF THE INVENTION

The unique clean operation of electric vehicles is highly desirable in urban areas, and much use of two wheelers is seen in urban areas due to traffic flow and parking considerations. Indeed, the limited range of batteries and a recharging infrastructure in its infancy make urban areas the ideal location for electric two wheelers. The lower speed “stop-start” nature of urban driving which results in frequent use of the brakes makes this environment ideally suited to extending the vehicle range through the use of recovered energy in regenerative braking.

### BRIEF SUMMARY

Aspects of this disclosure may relate to a saddle-type vehicle that includes a saddle-type vehicle chassis, a front fork connected to the saddle-type vehicle chassis, a front wheel connected to the front fork, a rear wheel connected to the saddle-type vehicle chassis, and an electric motor connected to the rear wheel, where the electric motor is powered by a rechargeable energy storage system. The saddle-type vehicle may include a braking system that has a friction brake providing a first braking force to the front wheel of the saddle-type vehicle, a regenerative device coupled to the rear wheel, where the regenerative device may provide a second braking force and also generate an electric current when the rear wheel is decelerating, and where the electric current charges the rechargeable energy storage system, a brake actuation device configured for movement by an operator, one or more motor controllers coupled to the brake actuation device and the rechargeable energy storage system, and a brake actuation sensor operatively coupled to the brake actuation device. The brake system may operate such that when the brake actuation device is actuated, the one or more motor controllers activates the regenerative device to decelerate the rear wheel and create the electric current to charge the rechargeable energy storage system. The first braking force applied to the front wheel may be applied only by the friction brake, and the second braking force applied to the rear wheel may be applied only by the regenerative device or electric motor. The electric motor may include the regenerative device to provide both forward drive for the saddle-type vehicle and also to provide braking force to the rear wheel to decelerate the rear wheel. Both the friction brake connected to the front wheel and the regenerative device connected to the rear wheel may be activated together through actuation of the brake actuation device. In addition, the brake actuation device may be a lever assembly. The lever assembly may include the brake actuation sensor, where a movement of the lever assembly causes the brake actuation sensor to communicate data to the one or more motor controllers, where the one or more motor controllers use the data to calculate an amount of brake force required by the regenerative device to apply to the rear wheel. In addition, the lever assembly may be configured to be actuated by a hand of the operator or configured to be actuated by a foot of the operator.

Other aspects of this disclosure may relate to the brake system of the saddle-type vehicle where the electric motor includes the regenerative device to recover energy from deceleration of the rear wheel to charge the rechargeable energy storage system. The brake system may have one or more motor controllers that provide an Anti-Lock Brake function for the rear wheel. Further, the saddle-type vehicle may be a 2-wheeled vehicle, a 3-wheeled vehicle, or a four-wheeled vehicle. The brake system may operate such that when the friction brake includes an Anti-Lock Brake module, a wheel speed sensor may provide data to the Anti-Lock Brake module to enable the Anti-Lock Brake module to identify events that involve loss of traction. The wheel speed sensor may be a part of the electric motor or be connected to the rear wheel. In addition, the brake actuation sensor may be is a pressure sensor, a position sensor, or a magnetic position sensor. As another option, when power is restricted from the electric motor, the electric motor may be restricted from rotating causing the rear wheel to be immobilized.

Still other aspects of this disclosure may relate to a saddle-type vehicle that includes a saddle-type vehicle chassis, a front fork connected to the saddle-type vehicle chassis, a front wheel connected to the front fork, a rear wheel connected to the saddle-type vehicle chassis, and an electric motor connected to the rear wheel, where the electric motor is powered by a rechargeable energy storage system and also provides a driving force to the rear wheel. The vehicle may have a braking system that includes a friction brake that provides braking force to the front wheel of the saddle-type vehicle and a brake actuation device configured for movement by an operator. The brake system may operate such that when the brake actuation device is actuated, the friction brake may apply a first braking force to the front wheel and the electric motor applies a second braking force to the rear wheel causing the rear wheel to decelerate. In addition, when the rear wheel is decelerating, the electric motor may generate an electric current that charges the rechargeable energy storage system. Both the friction brake connected to the front wheel and the electric motor connected to the rear wheel may be activated simultaneously through actuation of the brake actuation device. The brake actuation device may include a brake actuation sensor, where a movement of the brake actuation device causes the brake actuation sensor to communicate data to one or more motor controllers. The one or more motor controllers may use the data to calculate an amount of the second braking force to apply to the rear wheel. The brake actuation device is a single lever assembly that is configured to be actuated by a hand of the operator.

### BRIEF DESCRIPTION OF THE DRAWINGS

The following Detailed Description will be better understood when considered in conjunction with the accompanying drawings in which like reference numerals refer to the same or similar elements in all of the various views in which that reference number appears. Also, the reader is advised that the attached drawings are not necessarily drawn to scale.

FIG. 1 illustrates a side front perspective view of an electric saddle vehicle according to one or more aspects described herein;

FIG. 2 illustrates a side rear perspective view of the electric saddle vehicle of FIG. 1 with some components removed according to one or more aspects described herein;

FIG. 3 illustrates a side front perspective view of the electric saddle vehicle of FIG. 1 according to one or more aspects described herein;

FIG. 4 illustrates a schematic of the braking system of the electric saddle vehicle of FIG. 1 according to one or more aspects described herein; and

FIG. 5 illustrates a flowchart of the braking system of the electric saddle vehicle of FIG. 1 according to one or more aspects described herein.

Further, it is to be understood that the drawings may represent the scale of different components of one single embodiment; however, the disclosed embodiments are not limited to that particular scale.

### DETAILED DESCRIPTION

In the following description of various example structures according to the invention, reference is made to the accompanying drawings, which form a part hereof, and in which are shown by way of illustration various example devices, systems, and environments in which aspects of the invention may be practiced. It is to be understood that other specific arrangements of parts, example devices, systems, and environments may be utilized and structural and functional modifications may be made without departing from the scope of the present invention. Also, while the terms “top,” “bottom,” “front,” “back,” “side,” “rear,” and the like may be used in this specification to describe various example features and elements of the invention, these terms are used herein as a matter of convenience, e.g., based on the example orientations shown in the figures or the orientation during typical use. Additionally, the term “plurality,” as used herein, indicates any number greater than one, either disjunctively or conjunctively, as necessary, up to an infinite number. Nothing in this specification should be construed as requiring a specific three-dimensional orientation of structures in order to fall within the scope of this invention.

The present disclosure may relate to a method to maximize the range of electric vehicles in an urban environment through recovered energy while reducing the complexity that results from having both an electric regenerative brake and friction brake on the same wheel. In addition, the present disclosure also may relate to a brake system design for a motorcycle or other saddle-type vehicle which includes one or more friction brakes on the front wheel(s) and an electric motor driving the rear wheel(s), or an electric hub motor integral to the rear wheel(s), used for both propelling the vehicle and regenerative braking to slow and stop it. These two braking systems may be linked to work together to slow the vehicle when the rider actuates a brake lever. The electric motor, or electric hub motor, may provide braking force to the rear wheel(s), recovering as much energy as possible while the friction brake may provide additional braking force through the front wheel(s) should the rider request more braking force than can be generated by the electric motor. The weight transfer to the front wheel(s) that occurs when a high and short saddle-type vehicle decelerates makes this application particularly suited to having friction braking only on the front wheel(s) and only using regenerative braking force to the rear wheel(s). Current brake systems that employ both friction and regenerative brakes on the same wheel require complicated systems to balance the braking force between the two systems. Adding an Anti-Lock Brake System (ABS) to this type of system further increases this complexity when all braking forces need to be able to be changed very rapidly to prevent the brakes from locking resulting in wheel skid and reduced control of the vehicle. The brake system as disclosed eliminates this complexity resulting in a simpler and lighter weight brake system.

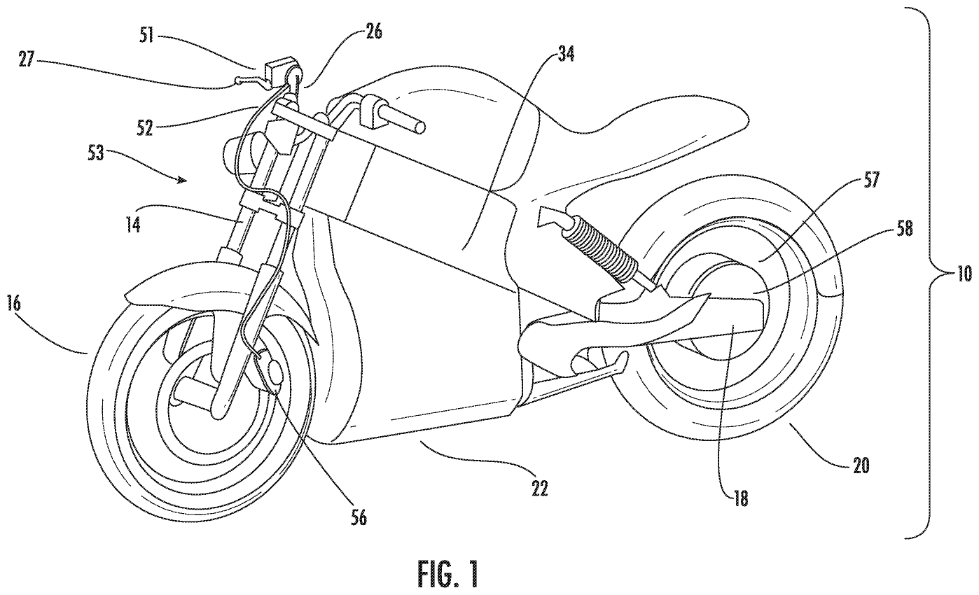

As shown in FIGS. 1-5, a saddle-type vehicle 10 may have a braking system 50 includes a friction brake 53 that acts upon the front wheel(s) 16 and an electric motor 57 that provides braking force to the rear wheel(s) 20 where both the friction brake 53 and the braking from the electric motor 57 are activated by the rider actuating a brake lever 27. A regenerative device 58 may be activated by the motor controller 55 when it receives a signal generated by a brake sensor 26. The regenerative device 58 may act to charge the rechargeable energy storage system (RESS) 24, which may include a battery and a battery management system, of the saddle-type vehicle 10. Regenerative braking is used as a means to recover some of the vehicle's kinetic energy and convert the kinetic energy to a form that can be stored for later use. As described herein, the kinetic energy of the moving vehicle may be converted into electricity by using the vehicle's electric motor as a generator (or a separate generator) when the brakes are applied. In a conventional friction braking system, the vehicle's kinetic energy is converted into heat, which is not recovered and becomes wasted energy.

FIG. 1 illustrates a motorcycle, or saddle-type vehicle, 10. The saddle-type vehicle 10 may include a saddle-type vehicle chassis 34, a front telescoping 14 connected to the saddle-type vehicle chassis 34, a front wheel 16 connected to the front fork 14, and a rear wheel 20 connected to the saddle-type vehicle chassis 34 by a swingarm 18. An electric motor 57 is connected to the swingarm 18 and to the rear wheel 20 such that the electric motor 57 drives the rear wheel 20. As discussed herein, the term “connected” may define that two elements are directly connected to each other such that the elements physically contact each other or the two elements may be indirectly connected such that the elements may be connected through one or more intermediary elements. The electric motor 57 may be powered by a rechargeable energy storage system (RESS) 24 that is located within housing 22 of the chassis 34. The saddle-type vehicle 10 may include a braking system 50 to decelerate or stop the vehicle 10. While the exemplary embodiment shown in FIGS. 1-3 illustrates a saddle-type vehicle that includes two wheels, the saddle-type vehicle may include three wheels, or may even four wheels. The configurations with three or more wheels may include a plurality of wheels located on either the front or rear of the saddle-type vehicle.

The braking system 50 may include a friction brake system 53 connected to the front wheel 16 mounted to the front fork 14, where the friction brake system 53 may provide the necessary braking force to the front wheel 16 of the vehicle 10. The frictional brake system 53 may include a caliper 56 containing brake pads, a master cylinder, a fluid reservoir 51, a brake actuation device 27, and a hydraulic hose 52. The braking system 50 may also include a regenerative braking system that includes a regenerative device 58 coupled to the rear wheel 20, where the regenerative device 58 may generate an electric current when the rear wheel 20 is decelerating such that the generated electric current charges the rechargeable energy storage system (RESS) 24. The regenerative device 58 may preferably be the electric motor 57 that acts as both the forward drive motor and as the regenerative device 58. However, in some examples, the regenerative device 58 may be a separate generator that charges the RESS 24 during deceleration of the rear wheel 20. The system 50 may also include a brake actuation device 27 that is configured for movement by an operator to allow the operator to easily engage and disengage the braking system 50. In addition, the actuation device 27 may be operatively coupled to a brake actuation sensor 26. The brake actuation sensor 26 may be a pressure sensor, a position sensor, or a magnetic position sensor. The brake system 50 may further include one or more motor controllers 55 coupled to the brake actuation device 27 and the rechargeable energy storage system (RESS) 24. When the brake actuation device 27 is actuated, the one or more motor controllers 55 may activate the regenerative device to decelerate the rear wheel 20 and also activate the friction brake system 53 to decelerate the front wheel 16. The deceleration of the rear wheel 20 by the regenerative device 58 may create an electric current to charge the rechargeable energy storage system 24.

As discussed above, the electric motor 57 may include the regenerative device 58 such that the electric motor 57 provides both the forward drive for the saddle-type vehicle 10 and also provides braking force to decelerate the rear wheel 20 when desired. In addition, when power is restricted from the electric motor 57, the electric motor 57 may be restricted from rotating causing the rear wheel to be immobilized. This immobilization may act as a theft deterrent.

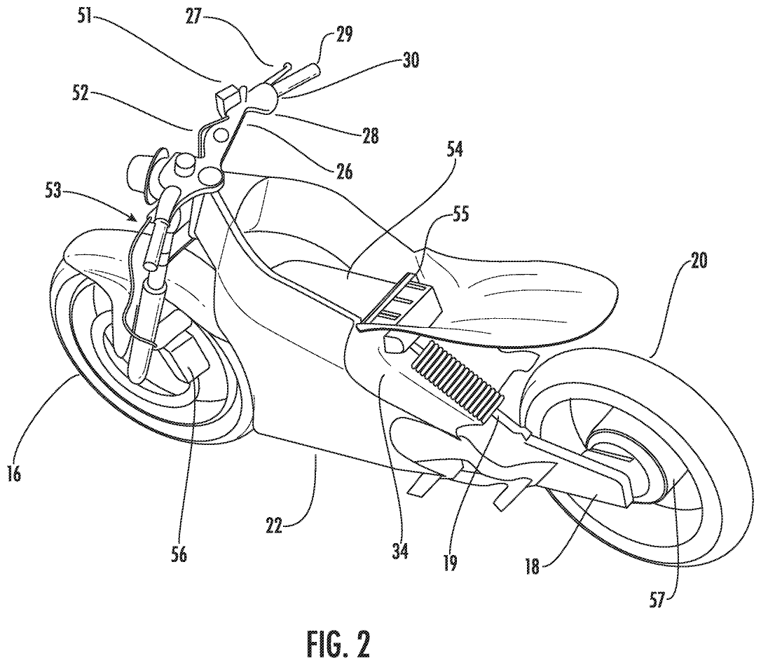

FIG. 2 illustrates brake lever 27 and sensor or switch 26 mounted to the right handle bar 29 which activates both the friction brake 53 and regenerative braking by electric motor 57. In some exemplary systems, the brake actuation device 27 may be a single lever assembly that is configured to be operated by a hand of an operator. In other examples, the brake actuation device 27 may be a lever assembly that is configured to be operated by a foot of an operator. The lever assembly 27 may include the brake actuation sensor 26, where a movement of the lever assembly 27 may cause the brake actuation sensor 27 to send a signal, or communicate data, to the motor controller 55 and vehicle controller 54. The sensor 26 may be located in the hydraulic brake system and may be triggered in the initial portion of the stroke of the brake lever 27. The friction brake 53 may be applied as the result of hydraulic pressure generated by further displacement of the brake lever 27. The motor controller 55 and/or vehicle controller 54 may then use the signal or data to calculate an amount of brake force required by the electric motor 57, or regenerative device, to apply to the rear wheel 20. Activating brake lever 27 and sensor or switch 26 may provide hydraulic pressure to the front brake generating braking force and also generates a signal to motor controller 55 to activate the regenerative braking function of electric motor 57 to combine front and rear braking forces to efficiently slow or stop the vehicle 10 and recover energy to the RESS 24 which may be located in housing 22. For example, as an operator physically moves the brake actuation device 27, the initial movement causes an increase in pressure to develop in the hydraulic hose 52. This initial pressure increase is detected by sensor 26, which then communicates data to the one of the motor controller 55 and/or vehicle controller 54. The controllers 54, 55 may then calculate the amount of braking force and apply the calculated amount of braking force by activating the regenerative braking of the electric motor 57 (or regenerative device 58) connected to the rear wheel 20. Further movement of brake actuation device 27 builds additional pressure in hydraulic hose 52 and generates braking force in friction brake 53 connected to the front wheel 16. As such, in cases when the brake actuation device 27 receives only light movement, the regenerative brakes on the rear wheel 20 may engage first and then when the pressure from the brake actuation device 27 reaches a predetermined limit, both the front and rear brakes may engage to create braking force at both wheels 16, 20. Thus, for light braking activity, as much energy is retained in the system by using only the rear wheel 20.

In addition, the controllers 54, 55 may receive signals or data from one or more of the brake actuation sensor 26, the twist grip position sensor 30, the speed sensors in the electric motor 57, and the speed sensors at the front and rear wheels 16, 20. From this data, the motor controller 55 or vehicle controller 54 may calculate the required brake forces to balance the braking forces between the front and rear wheels 16, 20 in a controlled manner. In addition, the saddle-type vehicle 10 may include one or more attitude sensors to detect any angular tilt of the wheels 16, 20 relative to the surface the vehicle 10 is traveling. These attitude sensors may include gyroscopes and/or accelerometers. In some examples, the controllers 54, 55 may use the data from these attitude sensors in conjunction with the data from the actuation sensor 26, the twist grip position sensor 30, and the speed sensors to determine the proper balanced braking force. Based on input from brake actuation device 27, brake actuation sensor or switch 26, twist grip sensor 30, and/or speed sensors integrated with the electric motor 57, the motor controller 55 (or vehicle controller 54) may control the braking force applied to the rear wheel 20 including providing an anti-lock brake system (ABS) function should it detect a rear wheel lock event. The motor controller 55 may use the signals from the brake actuation sensor 26 and the position of the twist grip sensor 30, which communicates the requested power for the electric motor 57, to calculate a desired braking force to be supplied by the regenerative device. Based on the inputs from the speed sensors should the controller detect a rear wheel lock it can adjust the amount of braking applied to the rear wheel to provide ABS function. Vehicle controller 54 also may receive the same signals from brake actuator lever 27 sensor or switch 26, twist grip sensor 30, speed sensors, and attitude sensors as the motor controller 55. As such if any failure in the motor controller 55 prevents the motor controller 55 from activating the brakes, the vehicle controller 54 will activate the rear brakes. Thus, the vehicle controller 54 provides redundant control of the braking system 50 and its regenerative braking to increase reliability. Additionally, in the case of a failure of hydraulic hose 52 or other components of the friction brake 53, the controller 55 can detect this failure based on the low output of brake pressure sensor 26 and use output from a different sensor, such as twist grip position, to provide redundant control of the rear brake further increasing reliability. Thus, the braking system has redundant systems to prevent a single point of failure within the brake system 50.

The vehicle controller 54 may control other functions on the vehicle 10 not related to the electric motor 57, such as controlling the lighting and opening storage compartments. As discussed above, the signals from the brake system 50, such as the signals from the brake actuator sensor 26, as well as the signals from the twist grip sensor 30. The vehicle controller 54 may also act as a redundant controller for safety related systems on the vehicle 10 similar such as described above with respect to the brake system 50.

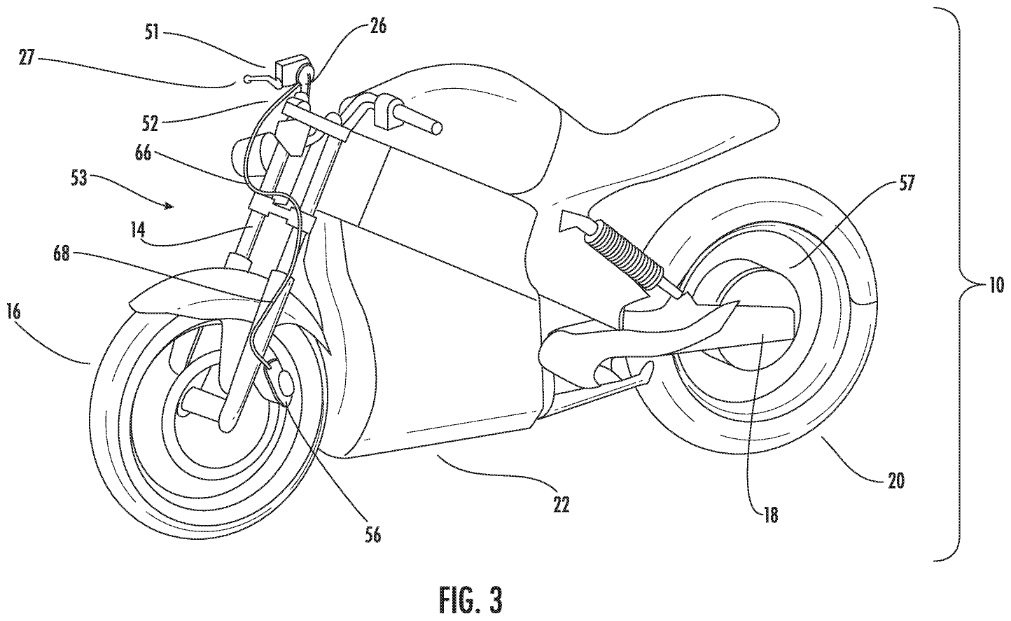

FIG. 3 shows an alternate example saddle-type vehicle with the addition of an Anti-Lock Brake System (ABS) module 66. In this example, hydraulic pressure is transmitted from brake lever 27 and sensor or switch 26 to the ABS unit 66 by hose 52 and from the ABS unit 66 to the front brake 53 by hose 68. When the friction brake 53 may include the ABS module 66, a wheel speed sensor may provide data to the ABS module 66 to enable the ABS module 66 to identify events that may involve a loss of traction. In some embodiments, the wheel speed sensor may be part of the electric motor 57, connected to the rear wheel 20, and/or connected to the front wheel 16. Motor controller 55 and vehicle controller 54 (see FIG. 2) may both receive a signal from ABS unit 66 to balance braking force between the front wheel 16 and rear wheel 20 to optimize energy recovery through regenerative braking. This exemplary embodiment may provide both friction and regenerative braking by implementing them independently with only a friction brake 53 connected to the front wheel 16 and with only a regenerative braking device (i.e. electric motor) connected to the rear wheel 20. The braking system 50 allows both the front and rear brakes to be activated by a single user input on the brake actuation device 27 to provide effective braking. Alternatively, the brake system may be implemented with the friction brake 53 attached to the rear wheel 20 and the electric motor 57 attached to the front wheel 16.

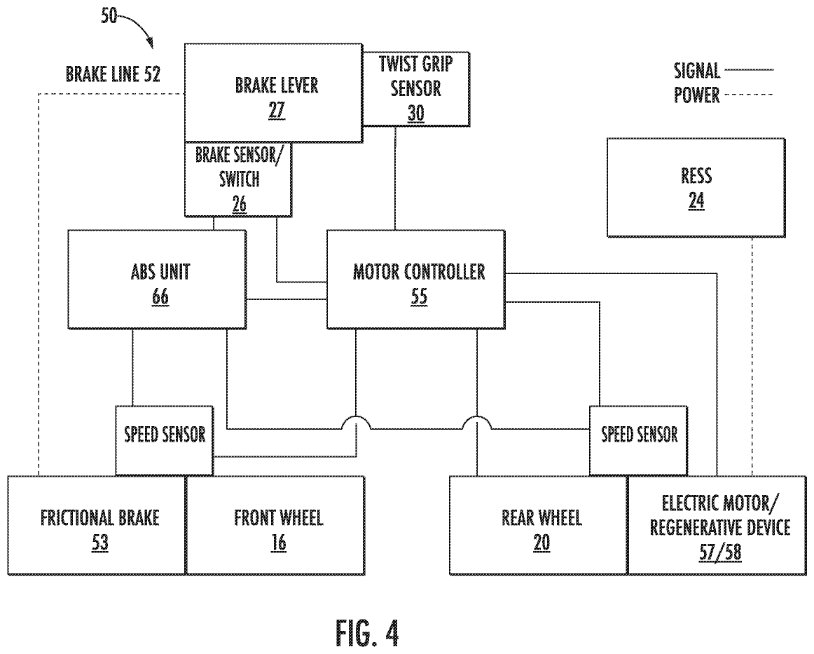

As shown in the schematic shown in FIG. 4, the brake actuation device 27, i.e. the brake lever, may be engaged with the calipers via a brake line 52. The brake actuation device 27 may also be connected with the brake actuation sensor 26, which may send a signal to both the motor controller 55 and the ABS unit 66. The ABS unit 66 may also receive signals from speed sensors located at the front wheel 16 and rear wheel 20 in order to detect a wheel lock event on either the front wheel 16 or rear wheel 20. The motor controller 55 may be connected and receive signals from the brake actuation sensor 26 and also from the twist grip sensor 30 to determine the necessary braking force to stop the rear wheel 20. The motor controller 55 may communicate with the ABS Unit 66 and the electric motor 57 to control the power and braking force on the rear wheel 20. Also, the electric motor 57 is connected to the RESS 24 to enable the regenerative braking of to recharge the RESS 24.

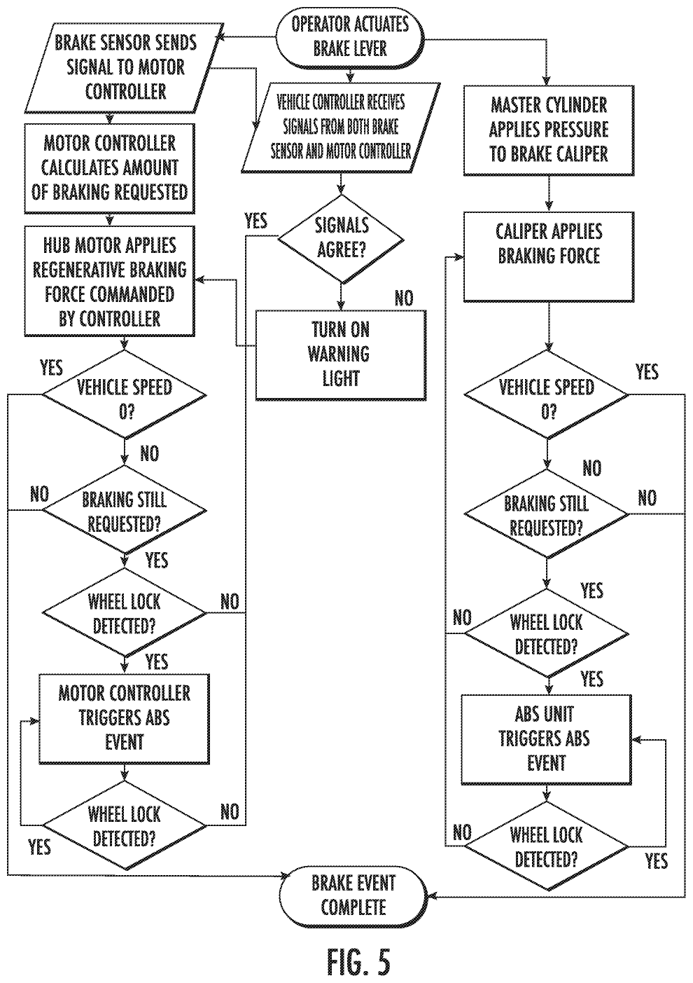

FIG. 5 displays the control system for the braking system 50. Initially, as the operator actuates the brake lever 27, the movement of the brake lever 27 activates the brake sensor 26. The brake sensor 26 then sends a signal to the motor controller 55 and as well as the vehicle controller 54. In addition, as the brake lever is actuated, the movement of the lever 27 causing the master cylinder to apply pressure to the brake caliper 56, which causes the caliper 56 to apply braking force to the front wheel 16. With respect to the rear wheel 20, once the motor controller 55 receives the braking signal from the brake sensor 26, the motor controller 55 may calculate the amount of braking force required and then send a signal to the electric motor 57, such that the electric motor 57 applies the desired regenerative braking force on the rear wheel 20. The ABS unit 66 may receive signals the speed sensors at the front wheel 16 and the rear wheel to monitor for a wheel lock event and react accordingly. For example, if a wheel lock event is detected at the rear wheel 20, motor controller 55 may control the electric motor 57 to provide an ABS response.

The present technology disclosed above and in the accompanying drawings reference a variety of example structures. The purpose served by the disclosure, however, is to provide an example of the various features and concepts related to the technology, not to limit the scope of the disclosure. One skilled in the relevant art will recognize that numerous variations and modifications may be made to the examples described above without departing from the scope of the present invention, as defined by the appended claims.

What is claimed is:

1. A saddle-type vehicle comprising:
a saddle-type vehicle chassis;
a front fork connected to the saddle-type vehicle chassis;
a front wheel connected to the front fork;
a rear wheel connected to the saddle-type vehicle chassis;
an electric motor connected to the rear wheel, wherein the electric motor is powered by a rechargeable energy storage system, and
a braking system including:
a friction brake providing a first braking force to the front wheel of the saddle-type vehicle,
a regenerative device coupled to the rear wheel, wherein the regenerative device provides a second braking force to the rear wheel and generates an electric current when the rear wheel is decelerating, and wherein the electric current charges the rechargeable energy storage system,
a brake actuation device configured for movement by an operator,
one or more motor controllers coupled to the brake actuation device and the rechargeable energy storage system, wherein when the brake actuation device is actuated, the one or more motor controllers activates the regenerative device to decelerate the rear wheel and create the electric current to charge the rechargeable energy storage system, and
a brake actuation sensor operatively coupled to the brake actuation device, wherein a movement of the brake actuation device causes the brake actuation sensor to communicate data to the one or more motor controllers, wherein the one or more motor controllers use the data to calculate an amount of brake force required by the regenerative device to apply to the rear wheel.

2. The saddle-type vehicle of claim 1, wherein the electric motor includes the regenerative device to provide forward drive for the saddle-type vehicle and also to provide braking force to the rear wheel to decelerate the rear wheel.

3. The saddle-type vehicle of claim 1, wherein the first braking force applied to the front wheel is applied only by the friction brake, and the second braking force applied to the rear wheel is applied only by the regenerative device.

4. The saddle-type vehicle of claim 1, wherein both the friction brake connected to the front wheel and the regenerative device connected to the rear wheel are activated together through actuation of the brake actuation device, and wherein the brake actuation device is a lever assembly.

5. The saddle-type vehicle of claim 4, wherein the lever assembly is configured to be actuated by a hand of the operator.

6. The saddle-type vehicle of claim 4, wherein the lever assembly is configured to be actuated by a foot of the operator.

7. The saddle-type vehicle of claim 1, wherein the one or more motor controllers adjusts the amount of braking force based on information received from attitude sensors on the saddle-type vehicle.

8. The saddle-type vehicle of claim 1, wherein the one or more motor controllers provides an Anti-Lock Brake function for the rear wheel.

9. The saddle-type vehicle of claim 1, wherein the saddle-type vehicle is a 2-wheeled vehicle.

10. The saddle-type vehicle of claim 1, wherein the saddle-type vehicle is a 3-wheeled vehicle.

11. The saddle-type vehicle of claim 1, wherein the saddle-type vehicle is a four-wheeled vehicle.

12. The saddle-type vehicle of claim 1, wherein when the friction brake includes an Anti-Lock Brake module, a wheel speed sensor provides data to the Anti-Lock Brake module to enable the Anti-Lock Brake module to identify events that involve loss of traction, and wherein the wheel speed sensor is part of the electric motor or connected to the rear wheel.

13. The saddle-type vehicle of claim 1, wherein when power is restricted from the electric motor, the electric motor is restricted from rotating causing the rear wheel to be immobilized.

14. The saddle-type vehicle of claim 1, wherein the brake actuation sensor is a pressure sensor.

15. The saddle-type vehicle of claim 1, wherein the brake actuation sensor is a position sensor.

16. The saddle-type vehicle of claim 1, wherein the brake actuation sensor is a magnetic position sensor.

17. A saddle-type vehicle comprising:
a saddle-type vehicle chassis;
a front fork connected to the saddle-type vehicle chassis;
a front wheel connected to the front fork;
a rear wheel connected to the saddle-type vehicle chassis;
an electric motor connected to the rear wheel, wherein the electric motor is powered by a rechargeable energy storage system and also provides a driving force to the rear wheel, and
a braking system including:
a friction brake providing braking force to the front wheel of the saddle-type vehicle; and
a brake actuation device configured for movement by an operator, wherein when the brake actuation device is actuated, the friction brake applies a first braking force to the front wheel and the electric motor applies a second braking force to the rear wheel causing the rear wheel to decelerate, and wherein when the rear wheel is decelerating, the electric motor generates an electric current that charges the rechargeable energy storage system.

18. The saddle-type vehicle of claim 17, wherein both the friction brake connected to the front wheel and the electric motor connected to the rear wheel are activated together through actuation of the brake actuation device.

19. The saddle-type vehicle of claim 18, wherein the brake actuation device includes a brake actuation sensor, wherein a movement of the brake actuation device causes the brake actuation sensor to communicate data to one or more motor controllers, wherein the one or more motor controllers use the data to calculate an amount of the second braking force to apply to the rear wheel.

20. The saddle-type vehicle of claim 17, wherein the brake actuation device is a single lever assembly that is configured to be actuated by a hand of the operator.
